(19) United States
(12) Patent Application Publication
(10) Pub. No.: US 2015/0179127 A1
(43) Pub. Date: Jun. 25, 2015

(54) LIQUID CRYSTAL DISPLAY DEVICE

(71) Applicant: AU OPTRONICS CORPORATION, Hsin-Chu (TW)

(72) Inventors: TSUNG CHENG LIN, HSIN-CHU (TW); SHYH FENG CHEN, HSIN-CHU (TW); SHIH CHYN LIN, HSIN-CHU (TW); HSIANG PIN FAN, HSIN-CHU (TW); KUEI SHENG TSENG, HSIN-CHU (TW)

(21) Appl. No.: 14/638,297

(22) Filed: Mar. 4, 2015

Related U.S. Application Data
(63) Continuation of application No. 12/437,110, filed on May 7, 2009.

(30) Foreign Application Priority Data
Jul. 2, 2008 (TW) 097124824

(51) Int. Cl. G09G 3/36

(52) U.S. Cl. CPC G09G 3/3696; G09G 3/3648; G09G 2320/0247; G09G 2320/0242; G09G 2300/0443

(57) ABSTRACT

A liquid crystal display device comprises a pixel matrix including a plurality of subpixels, wherein the voltage polarities of two horizontal adjacent subpixels are opposite to one another, and the voltage polarity of one subpixel in four serial subpixels along a diagonal direction is opposite to the voltage polarities of the other three subpixels.

### BACKGROUND OF THE INVENTION

1. Field of the Invention

The present invention relates to a liquid crystal display device, and more particularly, to a liquid crystal display device employing a polarity inversion driving method to improve the display quality thereof.

2. Description of the Related Art

Thin film transistor (TFT) liquid crystal displays (LCDs) generate images by applying voltages to field-generating subpixel electrodes to generate electrical fields, which align the liquid crystal molecules in a liquid crystal layer to produce the images. Generally, the TFTs are arranged as shown in FIG. 1. A TFT-LCD device 100 comprises a plurality of TFTs, a plurality of gate lines G1-Gm and a plurality of data lines D1-Dn disposed orthogonally to the gate lines G1-Gm. The TFTs T₁₁-Tₘₙ are disposed close to the cross-points of the gate lines G1-Gm and the data lines D1-Dn, and are connected correspondingly to subpixels P₁₁-Pₘₙ. During the image display process, the liquid crystal molecules in the region of each of subpixels P₁₁-Pₘₙ are driven by a respective voltage polarity applied by the respective TFT T₁₁-Tₘₙ in each frame, and the voltage polarity of each subpixel is reversed between plus and minus from one frame to another.

The methods used to drive the subpixels in every frame comprises a frame inversion driving method, a line inversion driving method, a column inversion driving method, a dot inversion driving method and a two-column inversion driving method.

The frame inversion driving method applies the same voltage polarity to each subpixel in every frame, and the voltage polarity of each subpixel is reversed from one frame to another. However, asymmetry between the positive pixel voltage and the negative pixel voltage arises due to capacitive coupling between the gate and the source/drain of a TFT so that a flicker occurs on the entire picture screen of an LCD.

When an LCD is driven by the line inversion driving method, the polarities of the voltage applied to the subpixels are reversed on a line-by-line basis. Because the polarities of the voltages of two adjacent lines are opposite, the flicker phenomenon can be eliminated. However, the subpixels along each line have the same polarity of voltage, and such a polarity arrangement causes serious crosstalk in the line direction.

The dot inversion driving method provides the reversed polarity of voltage to two adjacent subpixels in both the row and column directions respectively so that the flicker phenomenon and the crosstalk can be suppressed. However, when the intensity of an LCD is reduced by alternately turning off a portion of the subpixels, the turned-on subpixels in every frame may have the same voltage polarity and then the flicker phenomenon occurs. FIG. 2 shows an adjustment method of the luminous intensity of a prior art TFT-LCD. As shown in FIG. 2, the LCD 200a employs a dot inversion driving method. In order to reduce the intensity, a portion of the subpixels are turned off. Referring to the exemplary portion 202 of the three subpixels, the subpixel corresponding to red (R), having a positive polarity, and the subpixel corresponding to blue (B), also having a positive polarity, are both in the turned-on state, while the subpixel corresponding to green (G), having a negative polarity, is in the turned-off state. In the exemplary adjacent portion 204, the subpixel corresponding to red (R), having a positive polarity, and the subpixel corresponding to blue (B), having a positive polarity, are both in the turned-off state, while the subpixel corresponding to green (G), having a negative polarity, is in the turned-on state. Such an on/off arrangement can reduce the intensity of the LCD by half and reduce electricity consumption, yet has no negative effect on the color balance of the LCD. However, the turned-on subpixels do have the same polarities in each frame, so screen flicker may still occur.

FIG. 3 shows another adjustment method of the luminous intensity of a prior art TFT-LCD. The pixels of a TFT-LCD 200b are alternately turned off in a checkerboard pattern. The intensity of the TFT-LCD is cut in half and the electricity consumption thereof is reduced. As shown in FIG. 3, pixel 302 and pixel 304 of the TFT-LCD are in the turned-on state. The pixel 302 includes two subpixels having positive polarities and one subpixel having negative polarity, and the pixel 304 in the same row also includes two positive polarities and one negative polarity. Therefore, when the adjustment method is applied, the total number of subpixels having positive polarities is higher than the total number of subpixels having negative polarities, and such a situation can easily cause serious crosstalk in the row direction.

The two-column inversion driving method may avoid the flicker and crosstalk issues that the dot inversion driving method suffers from. However, the two-column inversion driving method introduces a color imbalance issue. FIG. 4 shows an adjustment method of the luminous intensity of a prior art TFT-LCD 400 driven by a two-column inversion driving method. The total numbers of positive polarities and negative polarities of the row that includes the turned-on pixel 402 and the turned-on pixel 404 are the same so that the polarities of the row are in balance and there is no cross talk in the row direction. However, due to the parasitic capacitance coupling effect to common electrode signals and the interference of the electrical field from data lines D1-Dn to subpixels, the two-column inversion driving method results in color imbalance. For example, in the turned-on pixel 402, the subpixel corresponding to R has positive polarity, and because the adjacent subpixel corresponding to G also has positive polarity, the luminous intensity of the subpixel corresponding to R will be lower; on the other hand, because the subpixel corresponding to B and next to the subpixel corresponding to G has negative polarity, the luminous intensity of the subpixel corresponding to G will be higher. As a result, the color of the pixel 402 will shift toward green. In the turned-on pixel 408, the subpixel corresponding to G has a negative polarity and the next subpixel corresponding to B also has a negative polarity so that the luminous intensity of the subpixel corresponding to G is lower and the color of the pixel 408 shifts toward purple. Consequently, the color of the image provided by the LCD 400 will alternate between green and purple along the row direction.

According to the above description, there is no driving method that can make TFT-LCDs provide images with good quality under different driving situations such as intensity adjustment by turning off a portion of the pixels. Therefore, a new driving method that can be used in different driving situations without any shortcomings is required by the LCD industry.

### SUMMARY OF THE INVENTION

The present invention proposes a liquid crystal display device, which employs a polarity inversion driving method. Under a particular display mode, two adjacent pixels will have different color subpixels that have higher luminous intensity. As such, the liquid crystal display will not display images with green and purple alternating colors across the images.

The present invention proposes a liquid crystal display device, which comprises a pixel matrix. The pixel matrix comprises a plurality of subpixels, wherein the voltage polarities of any two row-wise adjacent subpixels are opposite to one another and the voltage polarity of one subpixel in any four serial subpixels along any diagonal direction is opposite to the voltage polarities of the other three subpixels.

The present invention proposes a liquid crystal display device, which comprises a first pixel row, a second pixel row, a third pixel row, and a fourth pixel row. The first pixel row comprises a plurality of first subpixels along a horizontal direction, wherein the voltage polarities of the first subpixels are repetitiously applied in an order of a first polarity, the first polarity, a second polarity, and the second polarity from left to right. The second pixel row comprises a plurality of second subpixels along a horizontal direction, wherein the voltage polarities of the second subpixels are repetitiously applied in an order of the second polarity, the second polarity, the first polarity, and the first polarity from left to right. The third pixel row comprises a plurality of third subpixels along a horizontal direction, wherein the voltage polarities of the third subpixels are repetitiously applied in an order of the second polarity, the first polarity, the first polarity, and the second polarity from left to right. The fourth pixel row comprises a plurality of fourth subpixels along a horizontal direction, wherein the voltage polarities of the fourth subpixels are repetitiously applied in an order of the first polarity, the second polarity, the second polarity, and the first polarity from left to right; wherein the first polarity and the second polarity are opposite, and a first one of the first subpixels, a first one of the second subpixels, a first one of the third subpixels, and a first one of the fourth subpixels are aligned along a vertical direction.

In one embodiment, the first electrode strips are disposed along a first direction and the touch panel circuitry further comprises a plurality of substantially parallel second electrode strips, which are configured for generating a touch signal, and are arrayed along a second direction, wherein the first direction and the second direction can be mutually orthogonal.

### BRIEF DESCRIPTION OF THE DRAWINGS

The invention will be described according to the appended drawings in which:

FIG. 1 is a diagram for illustrating a TFT pixel arrangement in a prior art TFT-LCD;

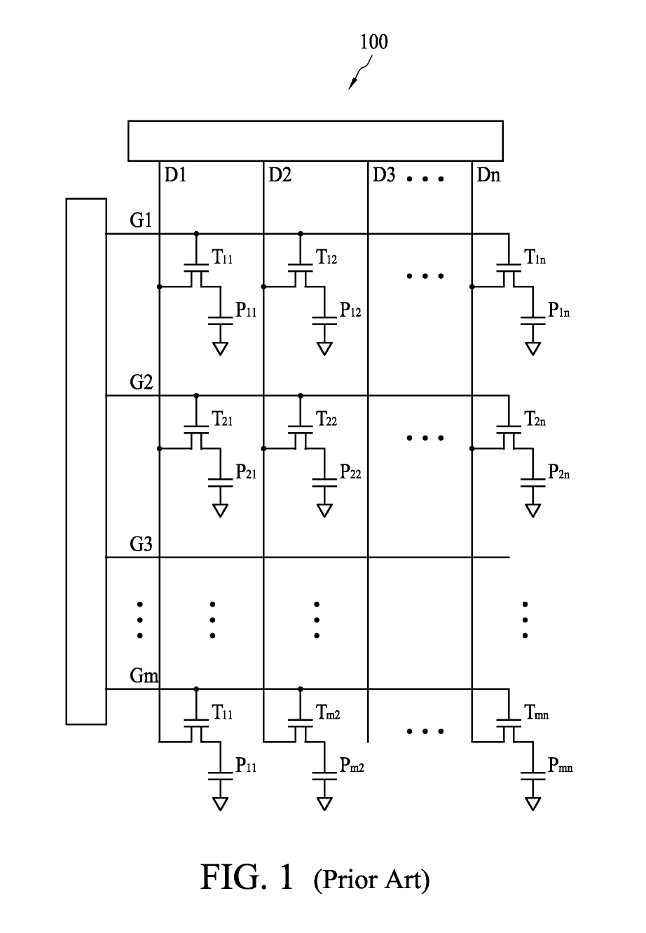

FIG. 2 shows an adjustment method of the luminous intensity of a prior art TFT-LCD;

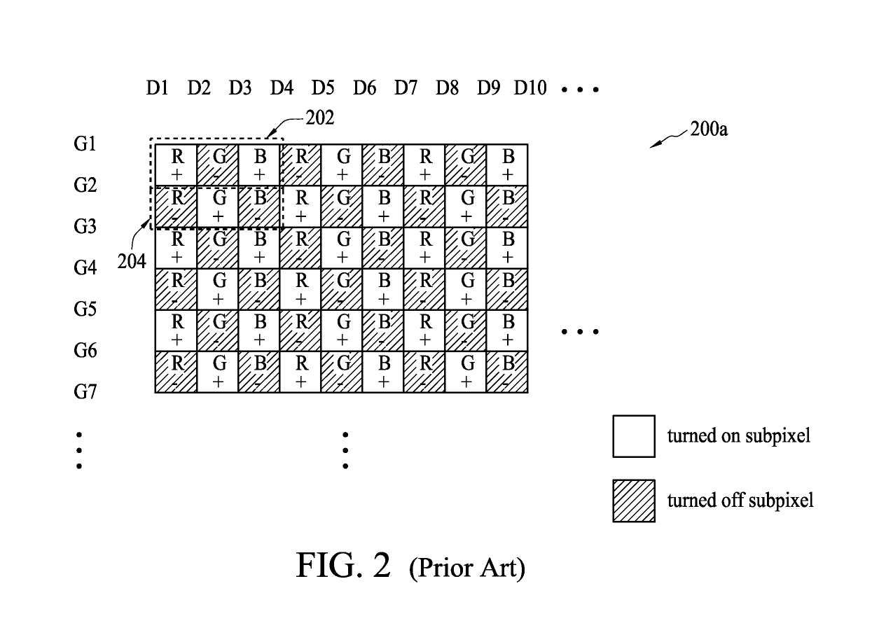

FIG. 3 shows another adjustment method of the luminous intensity of a prior art TFT-LCD;

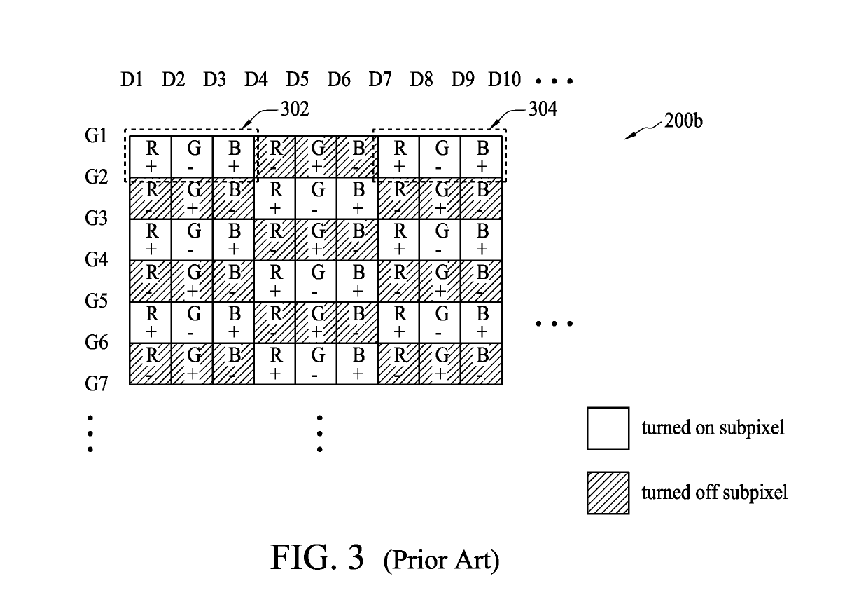

FIG. 4 shows an adjustment method of the luminous intensity of a prior art TFT-LCD driven by a two-column inversion driving method;

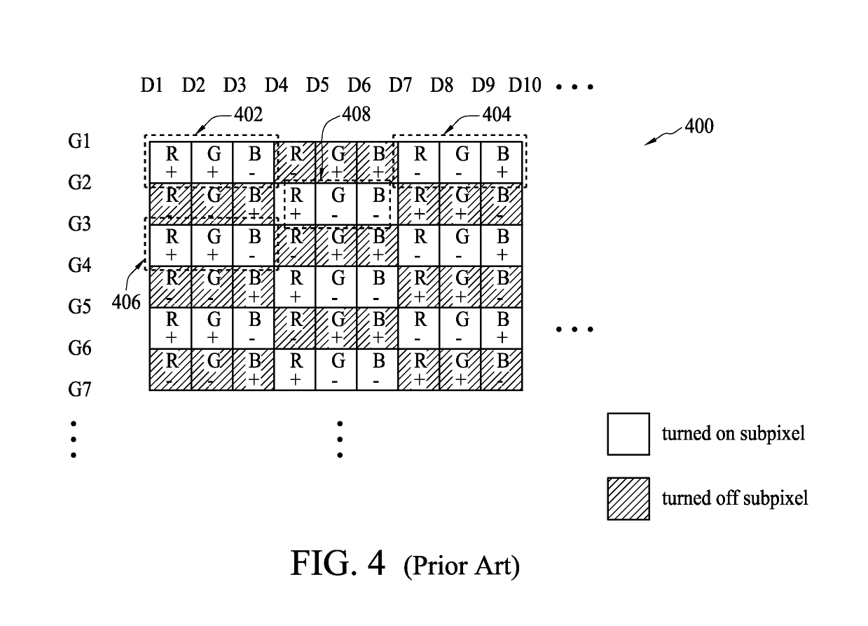

FIG. 5 is a diagram for illustrating an inversion driving method in a TFT-LCD device and an adjustment method of the luminous intensity of the TFT-LCD device according to one embodiment of the present invention;

FIG. 6 is an adjustment method of the luminous intensity of the TFT-LCD device according to another embodiment of the present invention; and

FIG. 7 is an adjustment method of the luminous intensity of the TFT-LCD device according to the other embodiment of the present invention.

### DETAILED DESCRIPTION OF THE INVENTION

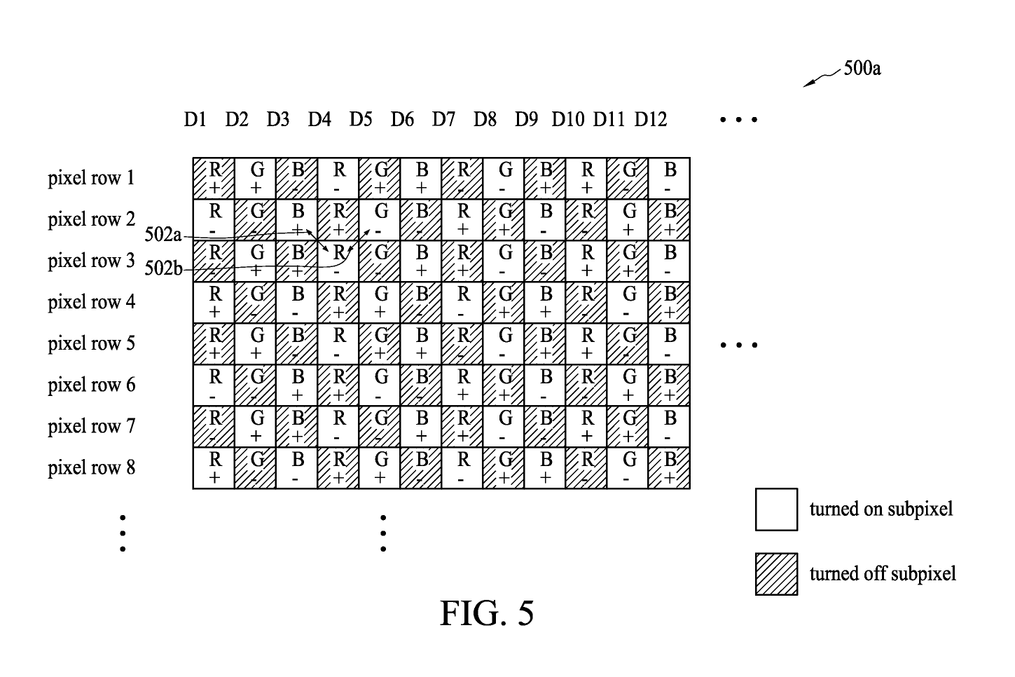

FIG. 5 is a diagram for illustrating an inversion driving method in a TFT-LCD device 500a and an adjustment method of the luminous intensity of the TFT-LCD device 500a according to one embodiment of the present invention. The TFT-LCD device 500a is driven by the inversion driving method such that the polarity of voltage is repetitiously reversed in a unit of two subpixels in each row of subpixels. All rows of subpixels comprise four row pixel polarity patterns, and the four row pixel polarity patterns are repetitiously arranged through the TFT-LCD device 500a. As shown in FIG. 5, the first two rows (Row 1 and Row 2) are respectively arranged according to two row pixel polarity patterns such that the polarity of voltage is repetitiously reversed in a unit of two subpixels in each row of subpixels and the polarities of voltage of two adjacent subpixels in the column direction are reversed. The next two rows (Row 3 and Row 4) are respectively arranged according to the other two row pixel polarity patterns such that the polarity of voltage is also repetitiously reversed in a unit of two subpixels in each row of subpixels and the polarities of voltage of two adjacent subpixels in the column direction are reversed, but each pixel (including R, G, and B subpixels) of the two rows is shifted by one pixel-position relative to the first two rows respectively in round-robin fashion. In the present embodiment, Row 3 and Row 4 are obtained by shifting each pixel (including R, G, and B subpixels) of Row 1 and Row 2 by one pixel-position to the left in round-robin fashion.

Referring to FIG. 5, the polarity arrangement of Row 1 is “plus, plus, minus, minus, . . . (++−− . . . )”; the polarity arrangement of the first pixel (RGB) is “plus, plus, minus (++−)”; and the polarity arrangement of the second pixel (RGB) is “minus, minus, plus (−−+).” The polarity arrangement of Row 2 is “minus, minus, plus, plus, . . . (−−++ . . . )”; the polarity arrangement of the first pixel (RGB) is “minus, minus, plus (−−+)”; and the polarity arrangement of the second pixel (RGB) is “plus, minus, minus (+−−).” The polarities of the subpixels of Row 1 and Row 2 are correspondingly reversed. The polarity arrangement of Row 3 is “minus, plus, plus, minus, . . . (−++− . . . ).” The polarity arrangement begins with the first pixel (RGB), the polarity arrangement of which is “minus, plus, plus (−++).” The polarity arrangement of Row 3 is the same as the sequential pixels of Row 1 using the second pixel of Row 1 as the first pixel. The polarity arrangement of Row 4 is “plus, minus, minus, plus, . . . (−++− . . . ).” The polarity arrangement of the first pixel (RGB) is “plus, minus, minus (+−−).” The polarity arrangement of Row 4 is the same as the sequential pixels of Row 2 using the second pixel of Row 2 as the first pixel. The polarity arrangements of Row 1 to Row 4 are repeated for Row 5 to Row 8 respectively and for successive rows. In the present embodiment, in Rows 1-4, the arrangement of colors corresponding to subpixels is in the sequence of red (R), green (G), and blue (B). In other embodiments, the color arrangement corresponding to subpixels can be a sequential repetition of any combination of R, G, and B.

Moreover, referring to FIG. 5, the voltage polarity of one subpixel in any four serial subpixels along any diagonal direction (502a or 502b) is opposite to the voltage polarities of the other three subpixels, and in each diagonal direction, a certain polarity arrangement continues repetitiously.

Referring to FIG. 5, under the operation mode with a checkerboard-like pattern such that subpixels treated in a unit are partially turned on and off (the subpixels with cross lines represent turned-off subpixels in FIG. 5), the polarity arrangement of the turned-on subpixels separated by one turned-off subpixel is alternately reversed along both row and column directions so as to avoid a flickering screen. Moreover, each row has equal numbers of positive and negative polarity subpixels so that the crosstalk in the row direction is suppressed.

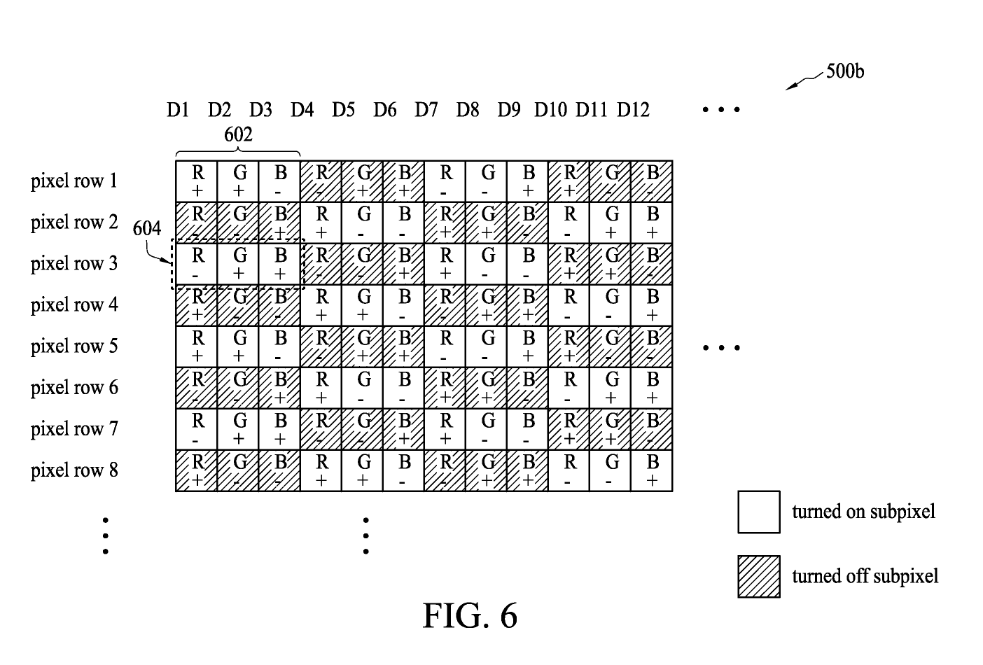

FIG. 6 is an adjustment method of the luminous intensity of the TFT-LCD device 500b according to another embodiment of the present invention. Under the pixel operation mode with a checkerboard-like pattern, pixels treated in a unit are partially turned on and off. Each row has equal numbers of positive and negative polarity subpixels similar to the embodiment shown in FIG. 5 so that the crosstalk in the row direction is suppressed. In the first column of pixels, for example, the subpixel in pixel 602, corresponding to R, has positive polarity, the subpixel corresponding to G has positive polarity, and the subpixel corresponding to B has negative polarity. Due to such a polarity arrangement, the luminous intensity of the subpixel corresponding to R is comparatively lower and the luminous intensity of the subpixel corresponding to G is comparatively higher. The subpixel in pixel 604, corresponding to R, has negative polarity, the subpixel corresponding to G has positive polarity, and the subpixel corresponding to B has positive polarity. Due to such a polarity arrangement, the luminous intensity of the subpixel corresponding to G is comparatively lower and the luminous intensity of the subpixel corresponding to R is comparatively higher. Such a result can minimize color imbalance of a screen image, which causes the color of the image to alternate between green and purple along a line direction. Consequently, the compensation for color imbalance between turned-on pixels (for example, the lower luminous intensity of the R subpixel in pixel 602 is compensated by the R subpixel in pixel 604 which has higher luminous intensity; the lower luminous intensity of the G subpixel in pixel 604 is compensated by the G subpixel in pixel 602 which has higher luminous intensity) can reduce asymmetry between the positive pixel voltage and the negative pixel voltage due to capacitive coupling between the gate and the source/drain of a TFT, and the interference of the electrical field from data lines D1-Dn to subpixels so that the color of the screen image can be uniformly provided without suffering from the issues of prior art driving methods.

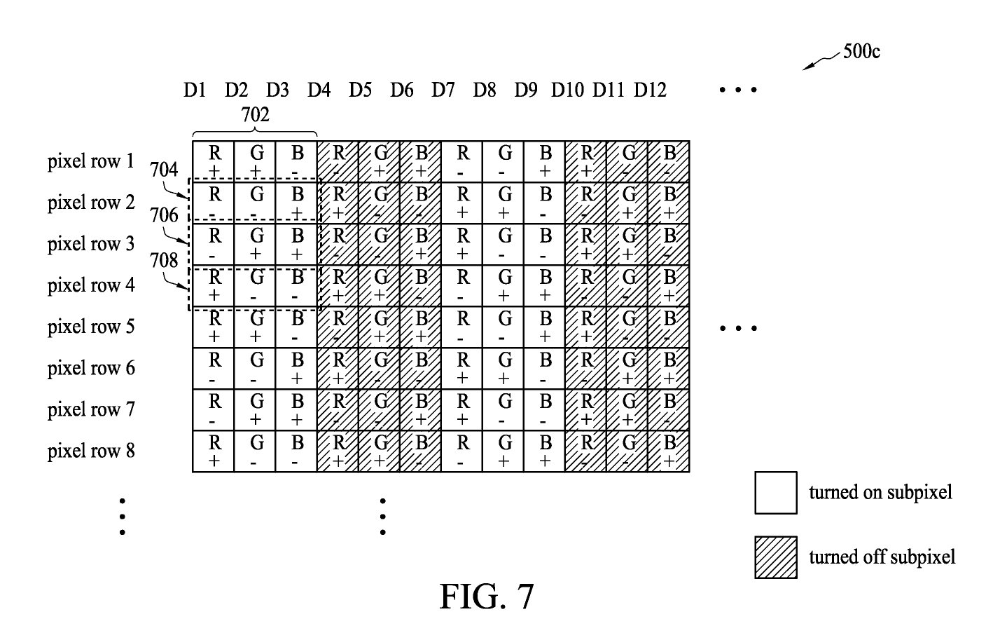

FIG. 7 is an adjustment method of the luminous intensity of the TFT-LCD device 500c according to the other embodiment of the present invention. Under the operation mode such that pixels treated in a unit are alternately turned on and off, each row has equal numbers of positive and negative polarity subpixels, just as with the embodiment shown in FIG. 5, so that the crosstalk in the row direction is suppressed. In the first column of pixels, for example, the subpixel in pixel 702, corresponding to R, has positive polarity, the subpixel corresponding to G has positive polarity, and the subpixel corresponding to B has negative polarity. The subpixel in pixel 704, corresponding to R, has negative polarity, the subpixel corresponding to G has negative polarity, and the subpixel corresponding to B has positive polarity. The subpixel in pixel 706, corresponding to R, has negative polarity, the subpixel corresponding to G has positive polarity, and the subpixel corresponding to B has positive polarity. The subpixel in pixel 706, corresponding to R, has negative polarity, the subpixel corresponding to G has positive polarity, and the subpixel corresponding to B has positive polarity. The subpixel in pixel 708, corresponding to R, has positive polarity, the subpixel corresponding to G has negative polarity, and the subpixel corresponding to B has negative polarity. Such a polarity arrangement in pixels has a similar effect as the embodiment shown in FIG. 6 and can minimize color imbalance of a screen image causing the color of the image to alternate between green and purple along a line direction. The color imbalance is varied in a unit of two rows and each unit is compensated by the next unit. For example, the lower luminous intensity of the R subpixels in pixel 702 and in pixel 704 is compensated by the R subpixels in pixel 706 and in pixel 708 which have higher luminous intensity; the lower luminous intensity of the G subpixels in pixel 706 and in pixel 708 is compensated by the G subpixels in pixel 702 and in pixel 704 which have higher luminous intensity. Such an effect of compensation can reduce asymmetry between the positive pixel voltage and the negative pixel voltage due to capacitive coupling between the gate and the source/drain of a TFT, and the interference of the electrical field from data lines D1-Dn to subpixels so that the color of the screen image can be uniformly provided without implying the issues of prior art driving methods.

The above-described embodiments of the present invention are intended to be illustrative only. Numerous alternative embodiments may be devised by persons skilled in the art without departing from the scope of the following claims.

What is claimed is:

1. A liquid crystal display device, comprising:
a first pixel row, comprising a first subpixel having a first voltage polarity in a first column, a second subpixel having the first voltage polarity in a second column, and a third subpixel having a second voltage polarity in a third column; the first subpixel immediately adjacent to the second subpixel, which in turn is immediately adjacent to the third subpixel;
a second pixel row, immediately adjacent to the first pixel row, and comprising a fourth subpixel in the first column, a fifth subpixel in the in second column, and a sixth subpixel in the third column; the fourth subpixel immediately adjacent to the fifth subpixel, which in turn is immediately adjacent to the sixth subpixel;
a third pixel row, immediately adjacent to the second pixel row, and comprising a seventh subpixel having the second voltage polarity in the first column, an eighth subpixel having the first polarity in the second column, and a ninth subpixel having the first polarity in the third column; the seventh subpixel immediately adjacent to the eighth subpixel, which in turn is immediately adjacent to the ninth subpixel;
wherein the first column is immediately adjacent to the second column, and the second column is immediately adjacent to the third column, and
wherein the first subpixel of the first pixel row, the fourth subpixel of the second pixel row, and the seventh subpixel of the third pixel row in the first column are configured to emit a first color, and the second subpixel of the first pixel row, the fifth subpixel of the second pixel row, and the eighth subpixel of the third pixel row are configured to emit a second color.

2. The liquid crystal display device of claim 1, wherein the first subpixel in the first pixel row and the seventh subpixel in the third pixel row is configured to emit red; the second subpixel in the first pixel row and the eighth subpixel in the third pixel row is configured to emit green.

3. The liquid crystal display device of claim 1, wherein the first subpixel, the second subpixel and the third subpixel in the first pixel row and the seventh subpixel, the eighth subpixel and the ninth subpixel in the third pixel row are configured to be turned on simultaneously.

4. The liquid crystal display device of claim 1, wherein the first voltage polarity is opposite to the second voltage polarity.

5. The liquid crystal display device of claim 4, wherein the first voltage polarity is positive, and the second voltage polarity is negative.

6. The liquid crystal display device of claim 1, wherein the fourth subpixel of the second pixel row has the second voltage polarity, the fifth subpixel of the second pixel row has the second voltage polarity, and the sixth subpixel of the second pixel row has the first voltage polarity, the liquid crystal display device further comprising:
a fourth pixel row, immediately adjacent to the third pixel row and comprising a tenth subpixel having the first voltage polarity in the first column, an eleventh subpixel having the second voltage polarity in the second column, and a twelfth subpixel having the second voltage polarity in the third column; the tenth subpixel immediately adjacent to the eleventh subpixel, which in turn is immediately adjacent to the twelfth subpixel.

7. The liquid crystal display device of claim 6 wherein the third subpixel of the first pixel row, the sixth subpixel of the second pixel row, the ninth subpixel of the third pixel row, and the twelfth subpixel of the fourth pixel row have a third color.

8. The liquid crystal display device of claim 6, wherein the first subpixel to the twelfth subpixel are configured to be turned on simultaneously.

9. The liquid crystal display device of claim 6, wherein the first subpixel, the second subpixel, and the third subpixel in the first pixel row and the seventh subpixel, the eighth subpixel, and the ninth subpixel in the third pixel row are configured to be turned on simultaneously while the fourth subpixel, the fifth subpixel, and the sixth subpixel in the second pixel row, and the tenth subpixel, the eleventh subpixel and the twelfth subpixel in the fourth pixel row are configured to be turned off simultaneously.

10. The liquid crystal display device of claim 6, wherein the first voltage polarity is opposite to the second voltage polarity.

11. The liquid crystal display device of claim 10, wherein the first voltage polarity is positive, and the second voltage polarity is negative.

12. The liquid crystal display device of claim 6, wherein the second pixel row is arranged below the first pixel row, the third pixel row is arranged below the second pixel row, the fourth pixel row is arranged below the third pixel row, and the first pixel row, the second pixel row, the third pixel row and the fourth pixel row are arranged to repeat vertically.

13. The liquid crystal display device of claim 1, wherein the first pixel row further comprises a thirteenth subpixel, which is immediately adjacent to the third subpixel; the thirteenth subpixel having the second voltage polarity; an arrangement of the first voltage polarity and the second voltage polarity among the first subpixel, the second subpixel, the third subpixel and the thirteenth subpixel forming a first cycle; voltage polarities of subpixels in the first row being arranged repeatedly every four subpixels in accordance with the first cycle.

14. The liquid crystal display device of claim 6, wherein the second pixel row further comprises a fourteenth subpixel, which is immediately adjacent to the sixth subpixel; the fourteenth subpixel having the first voltage polarity; an arrangement of the first voltage polarity and the second voltage polarity among the fourth subpixel, the fifth subpixel, the sixth subpixel and the fourteenth subpixel forming a second cycle; voltage polarities of subpixels in the second row being arranged repeatedly every four subpixels in accordance with the second cycle;
wherein the third pixel row further comprises a fifteenth subpixel, which is immediately adjacent to the ninth subpixel; the fifteenth subpixel having the second voltage polarity; an arrangement of the first voltage polarity and the second voltage polarity among the seventh subpixel, the eighth subpixel, the ninth subpixel and the fifteenth subpixel forming a third cycle; voltage polarities of subpixels in the third row being arranged repeatedly every four subpixels in accordance with the third cycle;
wherein the fourth pixel row further comprises a sixteenth subpixel, which is immediately adjacent to the twelfth subpixel; the sixteenth subpixel having the first voltage polarity; an arrangement of the first voltage polarity and the second voltage polarity among the tenth subpixel, the eleventh subpixel, the twelfth subpixel and the sixteenth subpixel forming a fourth cycle; voltage polarities of subpixels in the fourth row being arranged repeatedly every four subpixels in accordance with the fourth cycle.

15. The liquid crystal display device of claim 1, the fourth subpixel immediately adjacent to the first subpixel and having the second voltage polarity; the fifth subpixel immediately adjacent to the second subpixel and having the second voltage polarity;
wherein the first subpixel in the first pixel row and the fifth subpixel in the second pixel row are configured to be turned off simultaneously while the second subpixel in the first pixel row and the fourth subpixel in the second pixel row are configured to be turned on simultaneously.

16. The liquid crystal display device of claim 15, the sixth subpixel immediately adjacent to the third subpixel and having the first voltage polarity; the seventh subpixel immediately adjacent to the fourth subpixel; the eighth subpixel immediately adjacent to the fifth subpixel; the ninth subpixel immediately adjacent to the sixth subpixel;
wherein the first subpixel, the third subpixel, the fifth subpixel, the seventh subpixel and ninth subpixel are configured to be turned off simultaneously while the second subpixel, the fourth subpixel, the sixth subpixel and eighth subpixel are configured to be turned on simultaneously.

17. A liquid crystal display device, comprising:
a first pixel row, including a first subpixel in a first column, and a second subpixel in a second column, the first subpixel immediately adjacent to the second subpixel; and
a second pixel row, immediately adjacent to the first pixel row, and including a third subpixel in the first column, and a fourth subpixel in the second column, the third subpixel immediately adjacent to the fourth subpixel;
wherein the first column is immediately adjacent to the second column;
wherein the first subpixel in the first pixel row and the fourth subpixel in the second pixel row are configured to be turned off simultaneously while the second subpixel in the first pixel row and the third subpixel in the second pixel row are configured to be turned on simultaneously;
wherein a voltage polarity of the second subpixel in the first pixel row is opposite to a voltage polarity of the third subpixel in the second pixel row.
